(19) United States
(12) Patent Application Publication
(10) Pub. No.: US 2015/0082236 A1
(43) Pub. Date: Mar. 19, 2015

(54) INFORMATION PROCESSING APPARATUS

(71) Applicant: Sharp Kabushiki Kaisha, Osaka (JP)

(72) Inventor: Takeshi MURAKAMI, Osaka-shi (JP)

(21) Appl. No.: 14/456,096

(22) Filed: Aug. 11, 2014

(30) Foreign Application Priority Data
Sep. 13, 2013 (JP) 2013-190095

(51) Int. Cl. G06F 3/0488; G06F 3/0484

(52) U.S. Cl. CPC G06F 3/0488; G06F 3/04847
USPC 715/781

(57) ABSTRACT

An information processing apparatus includes a display portion, a control portion that controls display of the display portion, and an operation input portion that receives operation input by a user, which includes a touch operation for the display portion, and the control portion displays a window on the display portion and performs display control of the window according to the operation input for the operation input portion. According to an operation of touching a plurality of points for the operation input portion, the control portion sets a rectangular area on a screen displayed on the display portion, and according to a state of image data in the rectangular area, causes predefined data concerning the image data to be stored in a predetermined storage portion that is defined as a storage destination in advance.

### CROSS-NOTING PARAGRAPH

This non-provisional application claims priority under 35 U.S.C. §119(a) on Patent Application No. 2013-190095 filed in JAPAN on Sep. 13, 2013, the entire contents of which are hereby incorporated herein by reference.

### FIELD OF THE INVENTION

The present invention relates to an information processing apparatus, and more specifically to an information processing apparatus in which image data in an arbitrary area of a display screen of a display is able to be cut out to be used.

### BACKGROUND OF THE INVENTION

Some information processing apparatuses such as a PC (Personal Computer), a tablet and other mobile information terminal have a function for selecting and cutting out an arbitrary area of an image displayed on a display portion, which is held in a storage portion such as a memory to be available.

For example, when a browser is activated in an information processing apparatus such as a PC to open a screen of an arbitrary website and a user selects and captures an image in an arbitrary area from this screen, the captured image is able to be filed or edited/processed to be used for various purposes as appropriate.

When an image in an arbitrary area is captured from an image displayed on a display screen of an information processing apparatus such as a PC, conventionally, for example, a user activates a screen cutting tool which is software running on the information processing apparatus and performs a drag operation for a mouse or a touch panel to thereby select the arbitrary area. Thereby, data of the display image in the selected area is held in a memory. Then, the user performs editing/processing and the like using the image held in the memory to use for an arbitrary purpose.

Alternatively, in another example of conventional capture processing, by pressing “Print Screen” which is one of keys of a keyboard for a computer when an image is displayed on a display portion of an information processing apparatus, it is possible to hold the display image.

The Print Screen is used for a purpose of copying a screen image which is displayed to a clipboard or the like in order to take a screenshot. When the Print Screen is pressed, it is possible that bitmap of the screen image displayed in the information processing apparatus is copied to the clipboard or a similar storage area, and the bitmap copied to the clipboard or the like is inserted (pasted) to a screen of image processing software as the screenshot for a document or the like. The user is able to operate the screen of the image processing software to cut out an image in an arbitrary area to store in a memory.

Alternatively, in still another example of the conventional capture processing, a file manager that runs on an information processing apparatus is able to be used. The file manager is software that provides a user interface for dealing with a file system, and enables an operation for a file itself such as moving, copying deleting or searching of a file, and an operation such as creating or moving of a directory and a folder. When a user activates the file manager in the information processing apparatus to select a target file and perform a copying operation, the selected file is copied and held in a memory temporarily. Using the file held in the memory, an image or the like included in the file is able to be processed arbitrarily.

As to a technology for designating an area in a display screen, for example, Japanese Laid-Open Patent Publication No. H1-279289 discloses a display apparatus in which when coordinates of two points serving as diagonal points of a window are input, the window is displayed with corners thereof automatically rounded, and when it is subjected to hard copy, the rounded parts are returned to an original for output in a rectangular shape.

As described above, in an information processing apparatus, it is possible to cut out and capture a screen displayed on a display portion arbitrarily to hold in a memory or the like for using, however, in the conventional processing, it is necessary to activate a tool such as a screen cutting tool, image processing software or a file manager to perform a predetermined operation and it is impossible to cut out an image easily, thus being cumbersome.

Further, Japanese Laid-Open Patent Publication No. H1-279289 is for rounding corners of the window by designating two points of diagonal vertexes, but not for cutting out a display image arbitrarily.

### SUMMARY OF THE INVENTION

An object of the present invention is to provide an information processing apparatus enabling to select an arbitrary area of a display screen so that data concerning an image in the selected area is recorded and held with a simple operation.

An object of the present invention is to provide an information processing apparatus that includes a display portion for displaying an image, a control portion for controlling display on the display portion, and an operation input portion for receiving operation input by a user including a touch operation for the display portion, and the control portion displays a window on the display portion and performs display control of the window according to the operation input for the operation input portion, wherein the control portion sets a rectangular area on a screen displayed on the display portion, according to an operation of touching a plurality of points for the operation input portion, and causes predefined data concerning the image data to be stored in a predetermined storage portion that is defined as a storage destination in advance according to a state of image data in the rectangular area.

Another object of the present invention is to provide the information processing apparatus, wherein as a state of the image data in the rectangular area, when an entire area of one window is not included in the rectangular area, the control portion causes the storage portion to store still image data in the rectangular area.

Another object of the present invention is to provide the information processing apparatus, wherein as a state of the image data in the rectangular area, when an entire area of one window is included in the rectangular area, the control portion causes the storage portion to store predefined data according to a type of an image displayed in the window whose entire area is included.

Another object of the present invention is to provide the information processing apparatus, wherein the type of the image is defined according to a program for displaying the image.

Another object of the present invention is to provide the information processing apparatus, wherein the data to be stored in the storage portion according to the type of the image is able to be set variably by the operation input for the operation input portion.

Another object of the present invention is to provide the information processing apparatus, wherein the control portion sets the rectangular area as a rectangular area that is surrounded by four sides in a horizontal direction and a vertical direction of the display screen of the display portion, and in a case where a coordinate in the horizontal direction of the display screen is an X coordinate and a coordinate in the vertical direction of the display screen is a Y coordinate, when the operation of touching the plurality of points is performed by touching three places or four places concurrently for the display portion, sets the rectangular area by four sides including a maximum X coordinate, a minimum X coordinate, a maximum Y coordinate and a minimum Y coordinate of the touched positions at the three places or the four places.

### BRIEF DESCRIPTION OF THE DRAWINGS

FIG. 1 is a block diagram showing a main configuration of an information processing apparatus according to the present invention;

FIG. 2A and FIG. 2B are diagrams explaining processing for cutting out image data in the information processing apparatus according to the present invention;

FIG. 3A and FIG. 3B are other diagrams explaining processing for cutting out image data in the information processing apparatus according to the present invention;

FIG. 4 is a diagram explaining processing when the information processing apparatus selects a rectangular area based on touched positions;

FIG. 5A and FIG. 5B are diagrams explaining another example of processing for cutting out image data in the information processing apparatus according to the present invention;

FIGS. 6A and 6B are other diagrams explaining another example of processing for cutting out image data in the information processing apparatus according to the present invention; and

FIG. 7 is a flowchart explaining an example of processing in the information processing apparatus according to the present invention.

### PREFERRED EMBODIMENTS OF THE INVENTION

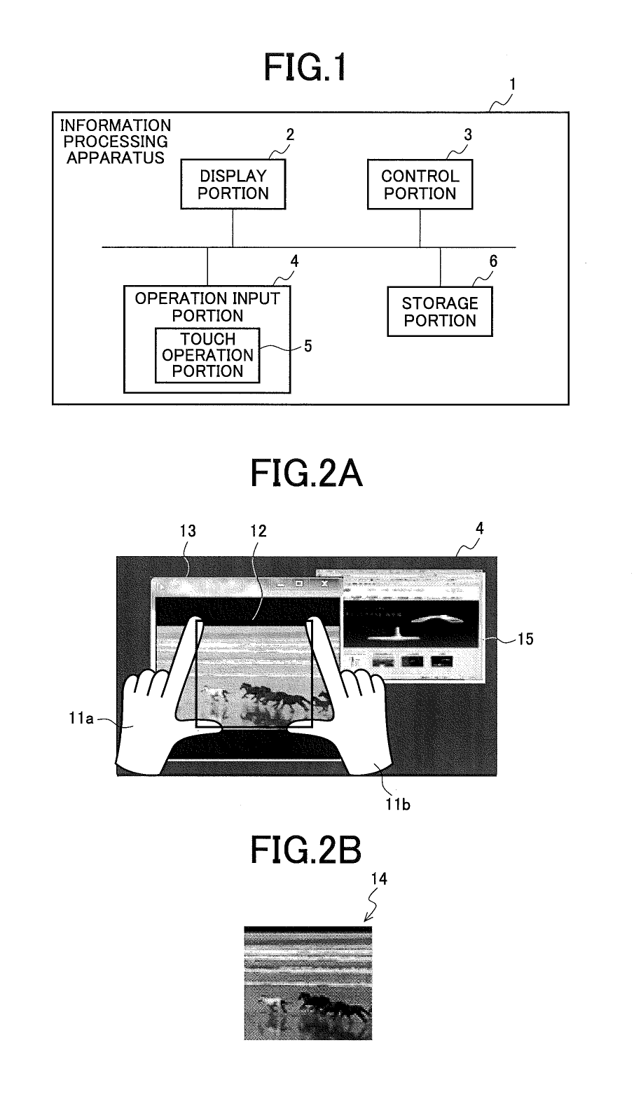

FIG. 1 is a block diagram showing a main configuration of an information processing apparatus according to the present invention. An information processing apparatus 1 is provided with a display portion 2, a control portion 3, an operation input portion 4 and a storage portion 6.

The control portion 3 is composed of a control processor such as a CPU (Central Processing Unit), and controls each portion of the information processing apparatus 1 using a program and data stored in the storage portion 6 to realize functions thereof.

The operation input portion 4 receives operation input by a user and includes a touch operation portion 5. The touch operation portion 5 is configured as a touch panel, and is comprised of a touch panel sensor arranged in the display portion 2 and a detection circuit therefor. The touch operation portion 5 is provided with a multi-touch detecting function capable of, when detecting a touch operation by an indicator such as a finger, multipoint input by a touch operation.

As the touch panel sensor, types such as an infrared type for detecting a block position using an infrared LED light source and a light receiving element, an electrostatic capacitance type for detecting a position by capturing a change in electrostatic capacity between a fingertip and a conductive film, a resistive film type for detecting voltage as an analog quantity by a resistive film, a surface elastic wave type (ultrasonic wave type) for detecting reflection of an oscillating wave by generation of voltage of a piezoelectric element, and an electromagnetic induction type for performing input by an electronic pen are able to be adopted.

The operation input portion 4 is able to be provided with a function for receiving operation input by a user, in addition to the touch operation portion 5. It is possible to enable operation input, for example, by a keyboard, a mouse or the like.

The storage portion 6 is storage means that includes a ROM (Read Only Memory) and an HDD (Hard Disk Drive) that store programs, data and the like for realizing each function of the information processing apparatus 1, and a RAM (Random Access Memory) that provides the control portion 3 with a work area. Moreover, the storage portion 6 is able to include an attachable/detachable memory such as a USB memory connected to the information processing apparatus and a storage device.

A storage area or a storage device, which is predefined as a storage destination for storing predefined data concerning image data, is set to the storage portion 6. As the predefined storage area or the like, a volatile memory such as a static RAM (Static Random Access Memory) which is used as a cache memory for storing image data and the like temporarily is able to be included, but the storage area or the like is not limited to the cache memory and may be set as appropriate. For example, a USB memory may be set as a storage destination. Moreover, a storage destination at which predefined data is stored is able to be set variably as appropriate according to operation input or the like for the operation input portion 4.

The display portion 2 is a display device that displays an image, such as a liquid crystal panel. When a user touches a surface of the display portion 2, the touch operation portion 5 detects input by the touch operation and provides the control portion 3 with information for specifying the input position (input coordinate information).

In response to the detection of the input by the touch operation portion 5, the control portion 3 acquires the input coordinate information which is detected, and judges at which position on the display screen of the display portion 2 the input coordinate is. Then, processing according to display for the display screen of the display portion 2 is performed based on the judgment result. For example, when drawing processing is performed for the display portion 2, the control portion 3 causes the display portion 2 to display by performing predetermined drawing at the input position based on the input to the touch operation portion 5.

In an embodiment according to the present invention, the information processing apparatus 1 sets a rectangular area based on touched positions to the display portion 2, and saves predetermined data concerning a display image in the rectangular area which is set in the storage portion 6. The predetermined data is determined according to a state of an image in the rectangular area, and is, for example, image data that is cut out by the rectangular area or data concerning an image displayed in a window in the rectangular area. At this time, different data is able to be held depending on a type of the display image in the rectangular area which is set. This makes it possible to hold data concerning a display image in an arbitrary area with a simple operation, thus making it possible to improve convenience of a user. An example of area selection and data saving will be described below specifically.

FIG. 2A and FIG. 2B are diagrams explaining processing for cutting out image data in the information processing apparatus according to the present invention.

In a first embodiment according to the present invention, only by touching four places (or three places) on a surface of the display portion 2, the information processing apparatus 1 sets a rectangular area based on the touched positions and causes the storage portion 6 to store image data of the set area. Storage of the image data in the storage portion 6 may be temporal storage in a cache memory and may be storage in other memory area or a storage area of other storage device. This makes it possible to cut out image data of an arbitrary area to store and hold in the storage portion 6 with a simple operation.

For example, as shown in FIG. 2A, it is set that the control portion 3 of the information processing apparatus 1 causes the display portion 2 to display an image including an active window 13 and a different window 15. A window is an area given to an application on a device such as a display in a window system, and a plurality of applications run concurrently in a multi-task operating system, so that a screen area is allocated to each of the applications in the window to be switched by a user operation. The window system is a mechanism on a computer in which a unique window is allocated to each of a plurality of tasks in parallel to multiplex screen output and software therefor, and provides a basic support for graphic hardware, a pointing device (such as mouse) and a keyboard.

A user touches arbitrary four places on the surface of the display portion 2 with fingertips of both hands 11a and 11b. When the touch operation portion 5 detects the touch operation, the control portion 3 selects a rectangular area 12 based on the touched positions. The touch operation is not limited to by fingertips as long as the touch operation portion 5 is able to detect the touched positions, but a simple operation is able to be performed by using both hands 11a and 11b for touching four places. At this time, the touched position may not be at four places, and may be at three places. Vertexes at three places among vertexes of a rectangle are able to be defined based on the touched positions at three places.

After setting the rectangular area 12, the control portion 3 judges a state of a display image displayed within the rectangular area 12. When the entire area of one window 13 is not included within the rectangular area 12, image data of the image displayed in the rectangular area 12 is cut out from the image data which is being displayed to be stored in the storage portion 6.

In the example of FIG. 2A and FIG. 2B, the user sets the rectangular area 12 including not the entire area of the active window 13 but a part of the area. Thereby, partial image data 14 in the window 13 as shown in FIG. 2B is cut out and stored in the storage portion 6.

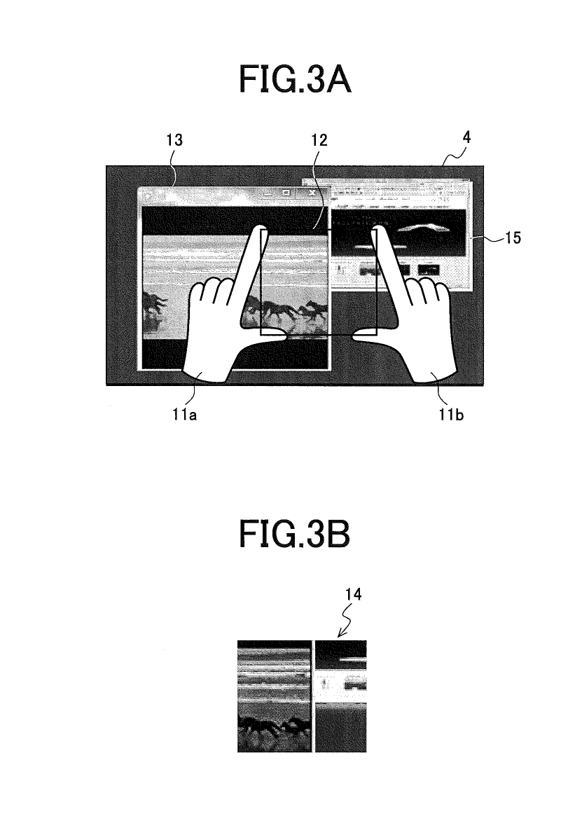

The setting of the rectangular area 12 may be in a form like FIG. 3A and FIG. 3B. In the example of FIG. 3A, when the user touches the display portion 2 to set a rectangular area 12, a part of a window 13 and a part of a window 15 are included within the rectangular area 12. In this case, since entire areas of the windows are not included within the rectangular area 12 as to neither the window 13 nor the different window 15, image data of an area in which the rectangular area 12 is set is cut out to be stored in the storage portion 6. Thereby, the image data 14 as shown in FIG. 3B is stored in the storage portion 6.

In the above-described example, regardless of a format of image data currently displayed (for example, data formats such as GIF, JPEG and PNG), the control portion 3 performs processing for cutting out and storing the image data. Moreover, when a moving image is being displayed, the control portion 3 is able to cut out image data of a still image at a time when the rectangular area 12 is set to store in the storage portion 6 as still image data.

Further, when a rectangular area is set, display may be performed explicitly so that the rectangular area is visible. Alternatively, when image data is stored, in order for a user to acknowledge that the image data is stored, display may be performed that shows that the image data is stored in the storage portion 6 by using pop-up display or the like.

The image data stored in the storage portion 6 is able to be used by the user as appropriate by appropriately being librarized for saving, or performing editing, processing or the like. Further, by successively executing setting of the rectangular area 12 by a multi-point touch operation a plurality of times, successive still image data in an arbitrary area is stored in the storage portion 6 to be available.

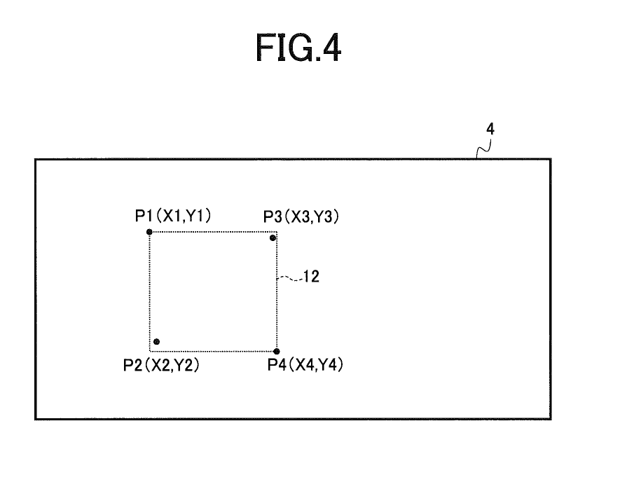

FIG. 4 is a diagram explaining processing when the information processing apparatus selects a rectangular area based on touched positions.

As described above, when a user touches four places on the surface of the display portion 2 and the touch operation portion 5 detects the touched positions, the control portion 3 sets a rectangular area 12 based on the touched positions. The four touched positions are not always at positions of vertexes of a rectangle, but are at positions where X coordinates and Y coordinates of touched position information thereof are deviated mutually. In this case, the control portion 3 sets a maximum rectangular area 12 including the touched positions.

For example, as shown in FIG. 3A and FIG. 3B, it is set that four touched positions are touched and coordinate positions of X and Y thereof P1 to P4 are P1 (X1, Y1), P2 (X2, Y2), P3 (X3, Y3) and P4 (X4, Y4), respectively. The X coordinate is set as a coordinate based on a coordinate axis matching a horizontal direction of the display screen, for example, with the upper-left vertex of the display screen as an origin. Moreover, the Y coordinate is set as a coordinate based on a coordinate axis matching a vertical direction of the display screen in the same manner.

In this case, the rectangular area 12 is set as a rectangular area that is surrounded by four sides in the horizontal direction or the vertical direction of the display screen of the display portion 2. When an operation of touching a plurality of points is performed by touching four places concurrently with respect to the display portion, the control portion 3 then sets the rectangular area 12 by four sides including a maximum X coordinate, a minimum X coordinate, a maximum Y coordinate and a minimum Y coordinate of the touched positions at four places.

Accordingly, in the example of FIG. 3A and FIG. 3B, an upper side of the rectangular area 12 is matched with a horizontal line on the screen passing P1 having the smallest Y coordinate. Moreover, a lower side of the rectangular area 12 is matched with a horizontal line on the screen passing P4 having the largest Y coordinate.

Similarly, a left side of the rectangular area 12 is matched with a vertical line on the screen passing P1 having the smallest X coordinate. Moreover, a right side of the rectangular area 12 is matched with a vertical line on the screen passing P4 having the largest X coordinate. In this manner, the control portion 3 sets the rectangular area 12 based on the four touched positions, and cuts out image data within the rectangular area 12 to store as a captured image. This makes it possible to prevent that necessary image data is deviated from the rectangular area 12.

The above-described processing is able to be performed similarly also when the rectangular area 12 is selected by touched positions at three places. That is, the rectangular area 12 is able to be set by four sides including a maximum X coordinate, a minimum X coordinate, a maximum. Y coordinate and a minimum Y coordinate of the touched positions at three places.

Whether to select the rectangular area 12 by touched positions at four places or to select the rectangular area 12 by touched positions at three places is able to be set to the information processing apparatus 1 in advance. Alternatively, a selection method thereof may be allowed to be set variably in the information processing apparatus 1.

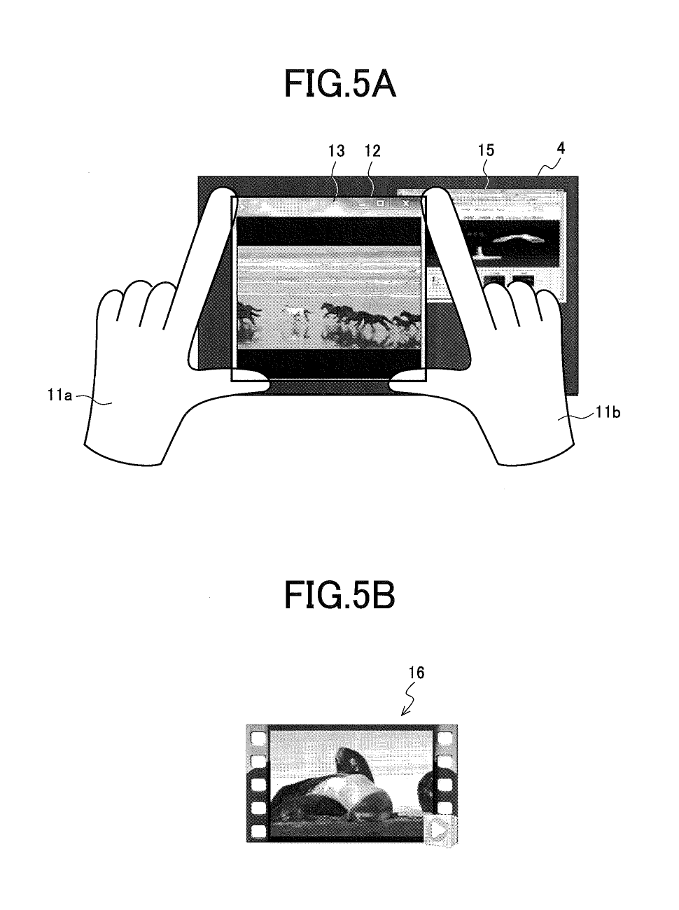

FIG. 5A and FIG. 5B are diagrams explaining another example of processing for cutting out image data in the information processing apparatus according to the present invention.

In a second embodiment according to the present invention, when four places (or three places) on the surface of the display portion 2 are touched, the information processing apparatus 1 sets a rectangular area 12 based on the touched positions, and when one window is entirely included within the rectangular area 12 which is set, performs processing for storing predefined data according to a type of an image displayed in the window.

For example, as shown in FIG. 5A, it is set that an image including an active window 13 and a different window 15 is displayed on the display portion 2 of the information processing apparatus 1. A user touches arbitrary four places (or three places) on the surface of the display portion 2 with fingertips of both hands 11a and 11b. When the touch operation portion 5 detects a touch operation, the control portion 3 sets a rectangular area 12 based on the touched positions. Processing for selecting this rectangular area 12 is the same as the processing described in FIG. 4 above.

After setting the rectangular area 12, the control portion 3 judges a state of a display image displayed within the rectangular area 12. At this time, when the entire area of one window 13 is included within the rectangular area 12, predefined data according to a type of an image displayed in the window 13 is stored in the storage portion 6. The type of the image displayed in the window is defined, for example, according to an application that is a program for displaying the image in the window.

For example, in the example of FIG. 5A and FIG. 5B, when the image displayed in the window 13, whose entire area is included within the rectangular area 12, is an image displayed by an application for playing a moving image file, the moving image file itself currently played by the application is copied from a storage source thereof and stored at a predetermined storage destination of the storage portion 6. FIG. 5B shows a moving image file 16 stored in the storage portion 6 conceptually.

For example, when the image displayed in the window 13 is an image generated by a media player, a media file currently played by the media player is copied to be stored in the storage portion 6. The media player is application software for playing a file of a moving image or audio on a computer, and allows playing corresponding to a plurality of file formats. In this case, it is possible to perform processing for copying a moving image file from a storage source such as an HDD in which a file of the displayed image is saved, and storing it at a predetermined storage destination of the storage portion 6.

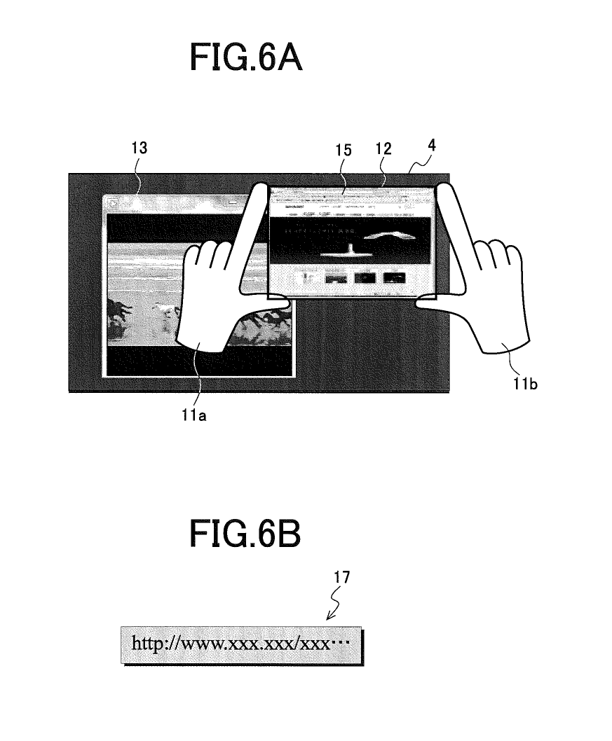

Moreover, in the example of FIG. 6A and FIG. 6B, when an image displayed in the window 15, whose entire area is included in the rectangular area 12, is an image displayed by a browser, a URL (Uniform Resource Locator) of a website from which the browser has acquired image data is stored in the storage portion 6. The URL is composed of a type of information, a server name, a port number, a folder name, a file name and the like. FIG. 6B shows a URL 17 stored in the storage portion 6 conceptually.

Further, as still another example of data setting according to a type of a display image in a window, for example, when the image displayed in the window 13 is an image displayed by an office suite application such as Microsoft Office (registered trademark), or an image by a predetermined file format concerning an electronic document such as PDF (registered trademark), a file of the displayed image is copied to be stored in the storage portion 6. In this case, it is possible to perform processing for copying a file from a storage source such as an HDD in which a file of the displayed image is saved, and storing it at a predetermined storage destination of the storage portion 6.

Further, as still another example, when the image displayed in the window 13 is an image generated by a file manager, data of a folder path that is a character string showing a location of the image displayed in the window 13 is stored in the storage portion 6. The file manager is an application that provides a user interface for dealing with a file system. The file manager makes it possible to perform a file operation such as moving, copying, deleting or searching of a file, and an operation such as creating or deleting of a directory and a folder.

Further, as still another example, when the image displayed in the window 13 is an image currently edited by various editors, a file of the displayed image is copied to be stored in the storage portion 6. In this case, it is possible to perform processing for copying a file from a storage source such as an HDD in which the file of the displayed image is saved, and storing it at a predetermined storage destination of the storage portion 6. The editor is an application for editing data, and allows to read data of a specific format from a file or other information source, for editing/processing and saving the read data or the like according to a user operation to a mouse or the like.

In this manner, the information processing apparatus 1 sets the rectangular area 12 based on touched positions on the display portion 2, and when one window is entirely included within the rectangular area 12 that is set, performs processing for storing data according to a type of an image displayed in the window. The data subjected to the storage processing is predefined according to the type of the image displayed in the window, but is able to be custom-set as appropriate by a user.

In this case, for example, according to operation input by the user for the operation input portion 4, data to be stored is able to be custom-set according to a type of the image displayed in the window. For performing custom-setting, for example, by preparing, in advance, a menu by which an application that is able to be set in the information processing apparatus and a type of data that is able to be subjected to storage processing according to the application are selectable, this menu may be displayed as appropriate so that predetermined data is set according to the user operation for the operation inupt portion 4.

Further, when a rectangular area is set, display may be performed explicitly so that the rectangular area is visible. Alternatively, when predetermined data is stored according to a type of an image displayed in a window, in order for a user to acknowledge that the data is stored, display may be performed that shows that the predetermined data is stored in the storage portion 6 by using pop-up display or the like.

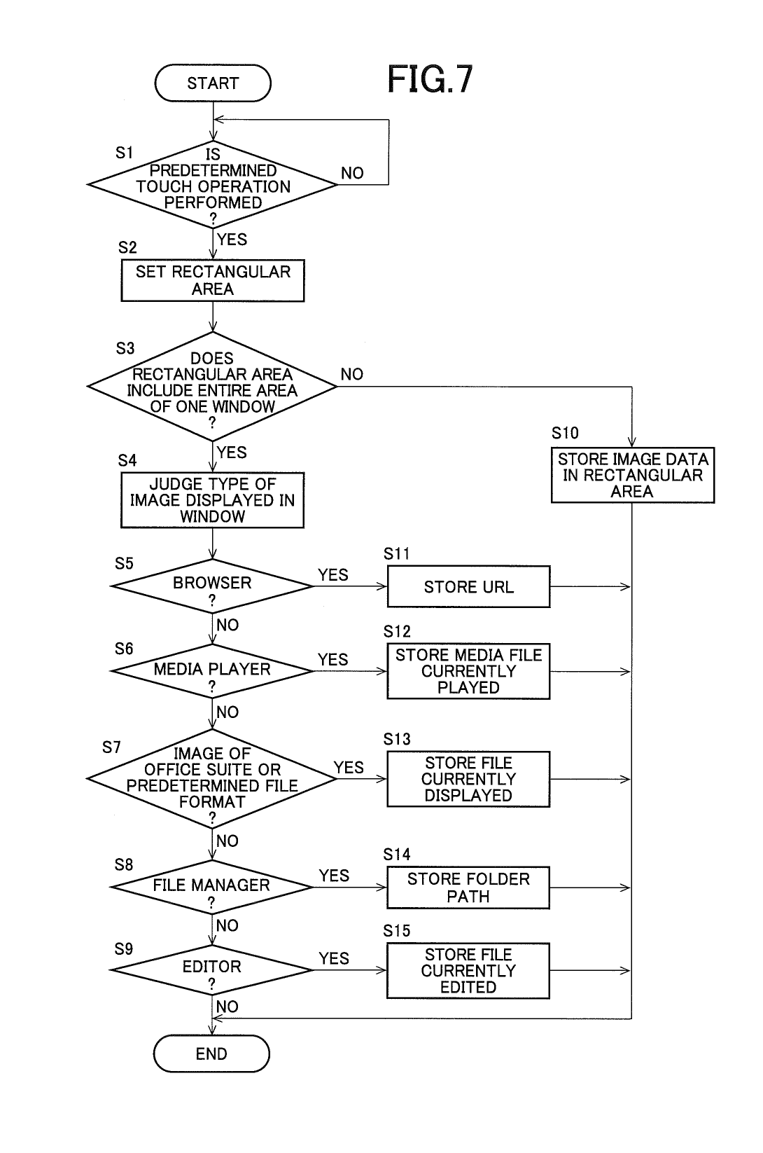

FIG. 7 is a flowchart explaining an example of processing in the information processing apparatus according to the present invention. Here, an example is shown that a case where an entire area of one window is included in a rectangular area which is set according to a touch operation and a case where it is not included are judged, and data storage processing according to each of the cases is executed. Description will be given below with reference to the configuration of FIG. 1.

The control portion 3 of the information processing apparatus 1 judges whether or not a predetermined operation is performed for the touch operation portion 5 (step S1). The predetermined operation is set to a touch operation for four places or a touch operation for three places, which are predefined to set a rectangular area.

When the predetermined operation is performed for the touch operation portion 5, the control portion 3 sets a rectangular area on the display screen of the display portion 2 in accordance with the touch operation (step S2).

The control portion 3 then judges whether or not the rectangular area which is set includes an entire area of one window displayed on the display portion 2 (step S3). Here, when the entire area of one window is not included in the rectangular area (step S3-No), image data in the rectangular area is cut out to be stored at a predetermined storage destination of the storage portion 6 (step S10).

On the other hand, when the entire area of one window is included in the rectangular area, the control portion 3 judges a type of an image displayed in the window (step S4). When the judged image is an image by a browser (step S5-Yes), then, a URL of a website from which the browser has acquired image data is stored in the storage portion 6 (step S11).

Further, when the judged image is an image generated by a media player (step S6-Yes), the control portion 3 copies a media file currently played by the media player to store at a storage destination of the storage portion 6 (step S12).

Further, when the judged image is an image of a predetermined file format concerning office suite or an electronic document (step S7-Yes), the control portion 3 copies a file of the currently displayed image to store at a storage destination of the storage portion 6 (step S13).

Further, when the judged image is an image generated by a file manager (step S8-Yes), the control portion 3 causes the storage portion 6 to store data of a folder path that is a character string showing a location of the image that is displayed in the window (step S14).

Further, when the judged image is an image currently edited by various editors (step S9-Yes), a file of the image currently edited is copied to be stored at a storage destination of the storage portion 6 (step S15). When the judged image is not one by an editor at step S9, it does not have a type of a display image that is defined so as to save predetermined data in advance, and therefore the processing is finished as it is.

As described above, by the processing of the information processing apparatus 1, it is possible to save predetermined data concerning a display image in a rectangular area that is set based on touched positions for the display portion 2 in the storage portion 6. Here, the predetermined data is determined according to a state of an image in the rectangular area, and it is possible that when an entire area of a window is not included in the rectangular area, image data that is cut out by the rectangular area is stored, and when an entire area of one window is included in the rectangular area, different data is stored according to a type of an image displayed in the window in the rectangular area. This makes it possible to hold data concerning a display image in an arbitrary area with a simple operation, thus making it possible to improve convenience of a user.

Technical features (components) described in each of the above-described embodiments are able to be combined with each other, and such combination makes it possible to form a new technical feature.

As above, according to the present invention, it is possible to provide an information processing apparatus enabling to select an arbitrary area in a display screen so that data concerning an image in the selected area is recorded and held with a simple operation.

1. An information processing apparatus that includes a display portion for displaying an image, a control portion for controlling display on the display portion, and an operation input portion for receiving operation input by a user including a touch operation for the display portion, and the control portion displays a window on the display portion and performs display control of the window according to the operation input for the operation input portion, wherein
the control portion sets a rectangular area on a screen displayed on the display portion, according to an operation of touching a plurality of points for the operation input portion, and causes predefined data concerning the image data to be stored in a predetermined storage portion that is defined as a storage destination in advance according to a state of image data in the rectangular area.

2. The information processing apparatus according to claim 1, wherein
as a state of the image data in the rectangular area, when an entire area of one window is not included in the rectangular area, the control portion causes the storage portion to store still image data in the rectangular area.

3. The information processing apparatus according to claim 1, wherein
as a state of the image data in the rectangular area, when an entire area of one window is included in the rectangular area, the control portion causes the storage portion to store predefined data according to a type of an image displayed in the window whose entire area is included.

4. The information processing apparatus according to claim 3, wherein
the type of the image is defined according to a program for displaying the image.

5. The information processing apparatus according to claim 3, wherein
the data to be stored in the storage portion according to the type of the image is able to be set variably by the operation input for the operation input portion.

6. The information processing apparatus according to claim 1, wherein
the control portion sets the rectangular area as a rectangular area that is surrounded by four sides in a horizontal direction and a vertical direction of the display screen of the display portion, and
in a case where a coordinate in the horizontal direction of the display screen is an X coordinate and a coordinate in the vertical direction of the display screen is a Y coordinate, when the operation of touching the plurality of points is performed by touching three places or four places concurrently for the display portion, sets the rectangular area by four sides including a maximum X coordinate, a minimum X coordinate, a maximum Y coordinate and a minimum Y coordinate of the touched positions at the three places or the four places.
